(19) United States
(12) Patent Application Publication
(10) Pub. No.: US 2010/0002825 A1
(43) Pub. Date: Jan. 7, 2010

(54) AUTOMATIC CONNECTION DEVICE AND METHOD FOR REMOTELY CONNECTING THE DUCTS FOR GUIDING A THERMOCOUPLE FOR THE UPPER INTERNALS OF A NUCLEAR REACTOR

(75) Inventors: Frederic Buchot, Epervans (FR); Laurent Cahouet, Chaudenay (FR)

Correspondence Address: CONNOLLY BOVE LODGE & HUTZ LLP, 1875 EYE STREET, N.W., SUITE 1100, WASHINGTON, DC, 20006, US

(73) Assignee: AREVA NP, Courbevoie (FR)

(21) Appl. No.: 12/139,789

(22) Filed: Jun. 16, 2008

(30) Foreign Application Priority Data
Apr. 12, 2007 (FR) 07 54422

(51) Int. Cl. G21C 19/00

(52) U.S. Cl. 376/260

(57) ABSTRACT

The invention relates to a device for connecting the upper (21) and lower (23) guide ducts for guiding a thermocouple for the upper internals of a nuclear reactor.

The device comprises a plug (41) fastened to the lower duct (23), comprising, on the one hand, a bore (43) for accommodating an end-piece (24) on the end of the upper duct (21) and, on the other hand, locking means (45) for locking it in a housing of a sleeve (32) of a tap (30), retaining means (48, 49) for keeping the plug (41) in the locked position in the sleeve (32), and means for blocking the plug (41) and for aligning the lower duct (23) and the upper duct (21) in said sleeve (32) of the tap (30).

The present invention relates to an automatic connection device and an automatic connection method for remotely connecting the upper and lower ducts for guiding a thermocouple for the upper internals of a nuclear reactor.

Pressurized-water nuclear reactors comprise, inside a vessel, the nuclear reactor core consisting of fuel assemblies of prismatic shape with their axis vertical and, above the core, upper internals comprising, in particular, an array of vertical guide tubes for guiding the control rods formed by bundles of fuel rods placed parallel to one another and containing a neutron-absorbing material.

To control the reactors by regulating the core reactivity, the clusters of absorber rods are moved in the vertical direction, during operation of the reactor, so that the absorber rods are introduced to a greater or lesser depth inside certain fuel assemblies of the core.

The upper internals comprise, in general, an upper plate, also called a support plate, and a lower plate constituting the upper core plate of the nuclear reactor, which bears on the upper end of the fuel assemblies when the upper internals are in the service position in the reactor core. The vertical guide tubes guiding the control rods are connected to the support plate and to the lower plate, which each have a first part inserted between the support plate and the lower plate and a second part fixed above this support plate. Support columns placed between the support plate and the lower plate, parallel to the guide tubes, are used to keep these plates in position and ensure the rigidity of the upper internals.

The upper internals also include instrumentation columns, such as thermocouple columns of cylindrical shape. Placed in each of the thermocouple columns is a group of thermocouples for measuring the temperature of the coolant at the outlet of a preselected group of fuel assemblies of the reactor core.

The number of thermocouple columns is generally two or four.

Each thermocouple column is not fixed to the support plate of the upper internals, but is guided by a shaft which extends vertically above this plate and penetrates into the thermocouple column. However, each thermocouple column is fastened to the closure head of the reactor vessel only by upper sealing means that are placed between a nozzle of an adapter fixed in an opening of the closure head and the upper part of the column.

Several thermocouples are therefore placed in a column and emerge from this column via peripheral openings made at the base of the column in order for each to be joined to a tap for passing through the support plate. For this purpose, each tap is provided with a guide tube placed in alignment with an orifice made in the support plate substantially plumb with a zone in which the temperature measurement has to be carried out. The thermocouple is introduced into an upper guide duct supported by the thermocouple column and by a lower guide duct placed in the tube of the corresponding tap. The sensitive measurement end of the thermocouple is positioned in the predetermined measurement zone.

After the reactor has operated for a certain time, it may be the case that several thermocouples no longer provide information so that it is no longer possible to have a reliable and representative image of the actual temperature of the coolant in the reactor core.

In addition, certain thermocouples may be unable to be extracted from the corresponding thermocouple column, so that it is necessary to completely replace the thermocouple column.

To do this, FR-A-2 883 096 teaches an assembly for remotely replacing at least one thermocouple column of a nuclear reactor.

This assembly for replacing at least one thermocouple column comprises an intermediate structure which is intended to be placed on the support plate by means of bearing elements and carries, fastened thereto, at least one replacement thermocouple column pre-equipped with upper guide ducts for guiding the new thermocouples down to each of the preselected taps. Thus, at the moment of placing on the upper support plate the intermediate structure carrying, fastened thereto, at least one replacement thermocouple column pre-equipped with upper guide ducts for guiding the new thermocouples, the end of each upper guide duct is introduced into each of the preselected taps and the new thermocouple is introduced into the upper guide duct and then into the corresponding lower guide duct down to the intended operating position.

The end of the upper guide duct must be placed in alignment with the lower guide duct so as to ensure continuity during introduction of the new thermocouple, while still allowing a slight misalignment. In addition, the two ducts must be fastened to the corresponding tap.

One object of the invention is therefore to provide an automatic connection device for remotely connecting, under water, the upper and lower ducts for guiding a thermocouple for the upper internals of a nuclear reactor, the upper internals comprising a support plate bearing:
guide tubes for the control rod clusters that regulate the reactivity of the core;
at least one thermocouple column containing at least an upper duct;
at least one tap for passage of the lower duct, which tap comprises a tube for guiding the lower duct and is provided, at its free end, with a sleeve for housing of said connection device, characterized in that it comprises:
a plug fastened to the lower duct, comprising, on the one hand, a bore for accommodating a conical end-piece on the end of the upper duct and, on the other hand, locking means for locking it in the housing of the sleeve;
retaining means for keeping the plug in the locked position in the sleeve of the tap; and
means for blocking the plug and for aligning the lower duct and the upper duct in the sleeve of said tap.

According to other features of the invention:
the means for locking the plug of the lower duct are formed by a quarter-turn type snap-fastening system;
the quarter-turn snap-fastening system comprises at least two opposed shoulders provided on the periphery of the plug, and a peripheral ring placed so as to be fastened to the sleeve in the housing of said sleeve and having at least two opposed passages for said shoulders;
the retaining means are formed by a collar for bearing on the shoulders of the plug and by a resilient compression member that exerts an upwardly directed vertical force in order to keep the shoulders clamped between the collar and the ring; and
the means of blocking and aligning the upper and lower ducts comprise, on the one hand, a nut mounted so as to rotate freely on the plug of the lower duct and intended to bear on the upper edge of the sleeve and, on the other hand, a fork for bearing on the end-piece of the upper duct and connected to said nut by at least one screwing member.

Another object of the invention is to provide an automatic connection method for remotely connecting, under water, the upper and lower guide ducts for guiding a thermocouple for the upper internals, by means of a device as mentioned above, characterized in that it consists:
in mounting the nut so as to rotate freely on the plug of the lower duct;
in introducing the lower duct equipped with the plug and with the nut into the tap;
in making the shoulders of the plug pass into the passages of the peripheral ring by compressing the resilient member;
in rotating the plug by a quarter of a turn in order to position the shoulders below the ring and thus lock the plug and the lower duct by clamping said shoulders between the collar and the peripheral ring under the restoring force of the resilient member;
in fitting the upper duct into the corresponding thermocouple column;
in placing the thermocouple column on the support plate, the conical end-piece on the end of the upper duct being housed in the accommodating bore of the plug;
in placing the fork on the nut;
in fastening the fork to the nut by at least one screwing member; and
in preventing said at least one screwing member from rotating.

The invention will be more clearly understood on reading the following description, given by way of example and with reference to the appended drawings in which:

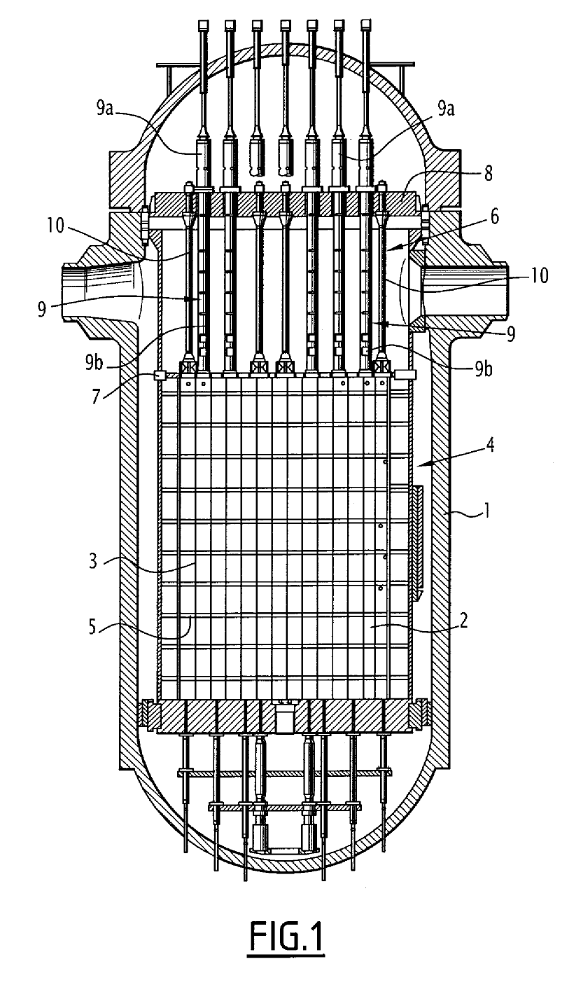

FIG. 1 is a schematic sectional view, in a vertical plane of symmetry, of the vessel of a pressurized-water nuclear reactor;

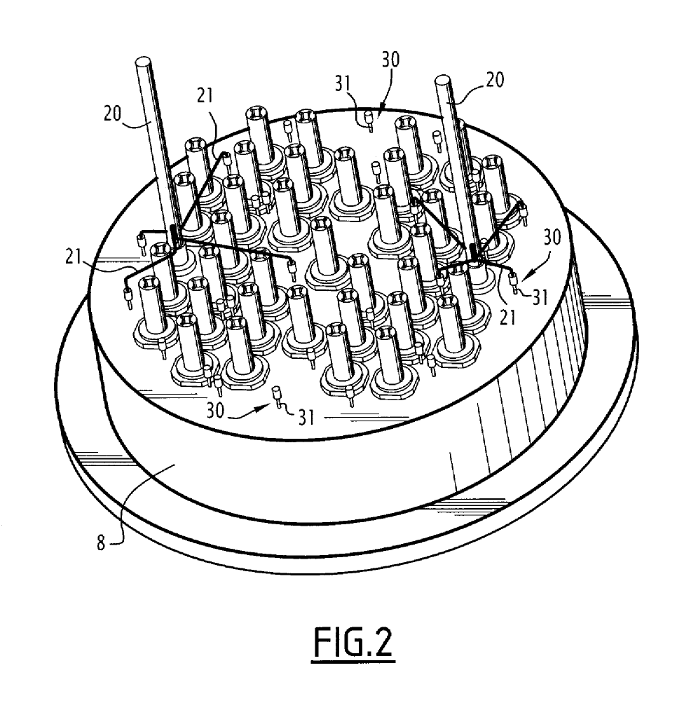

FIG. 2 is a schematic elevation view of the upper internals of a nuclear reactor in position on a servicing stand in the reactor pit in order to carry out an operation of replacing at least one thermocouple column;

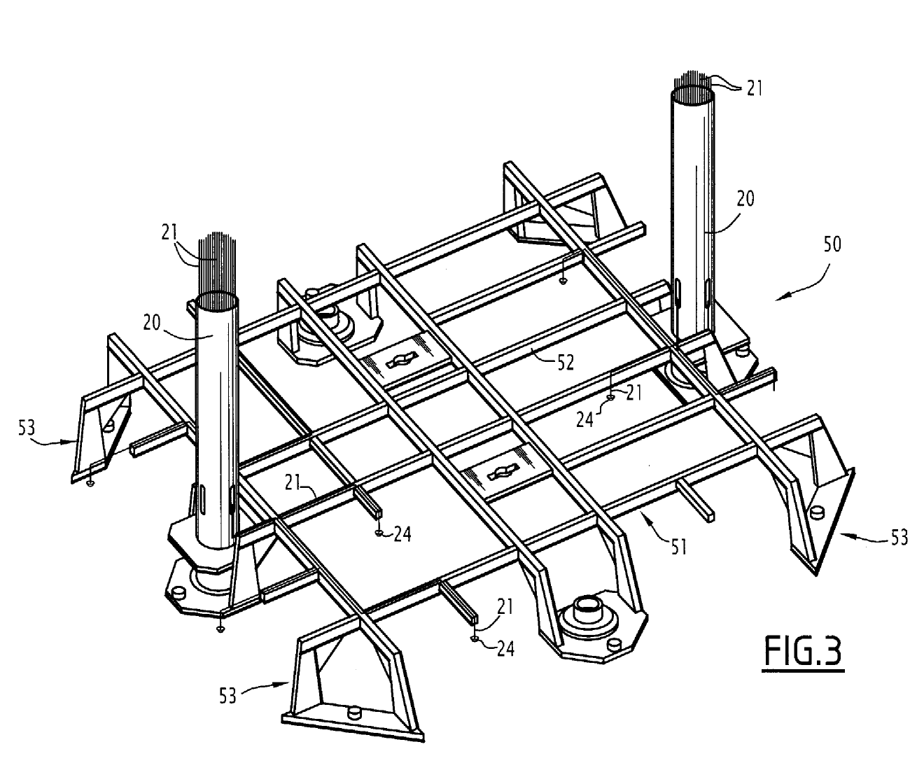

FIG. 3 is a perspective schematic view of an intermediate structure of an assembly for replacing at least one thermocouple column;

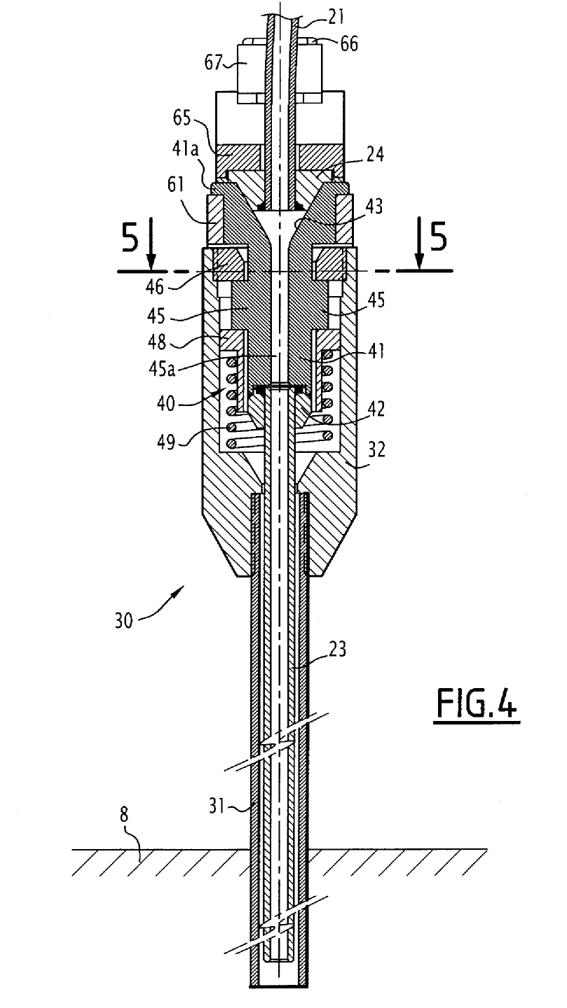

FIG. 4 is a schematic view in axial cross section of a device for automatically connecting the upper and lower guide ducts for guiding a thermocouple, in accordance with the invention;

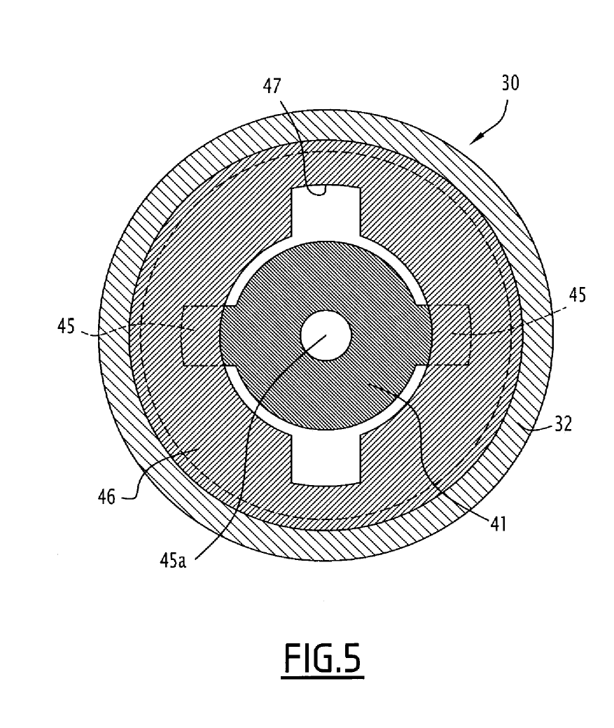

FIG. 5 is a cross-sectional view on the line 5-5 of FIG. 4; and

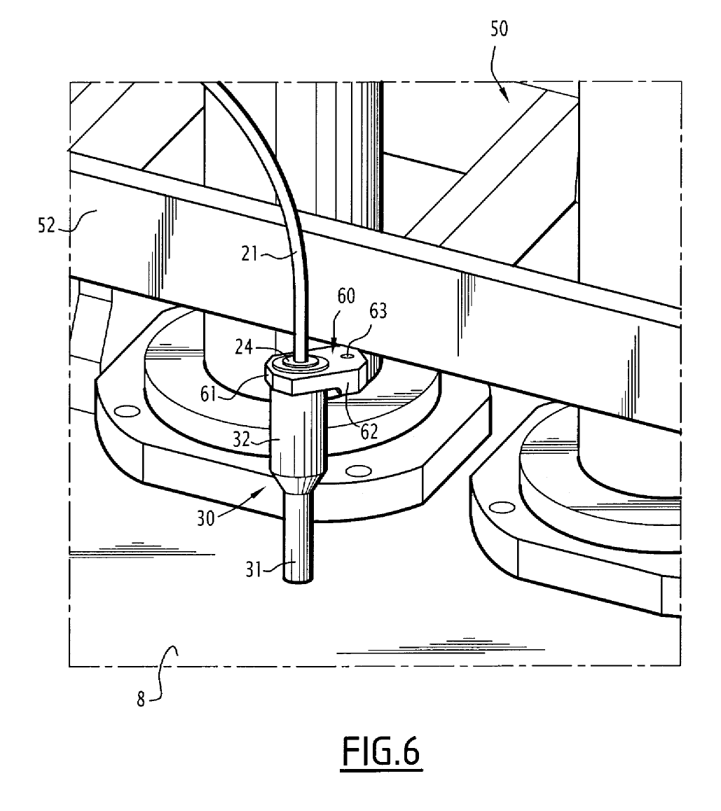

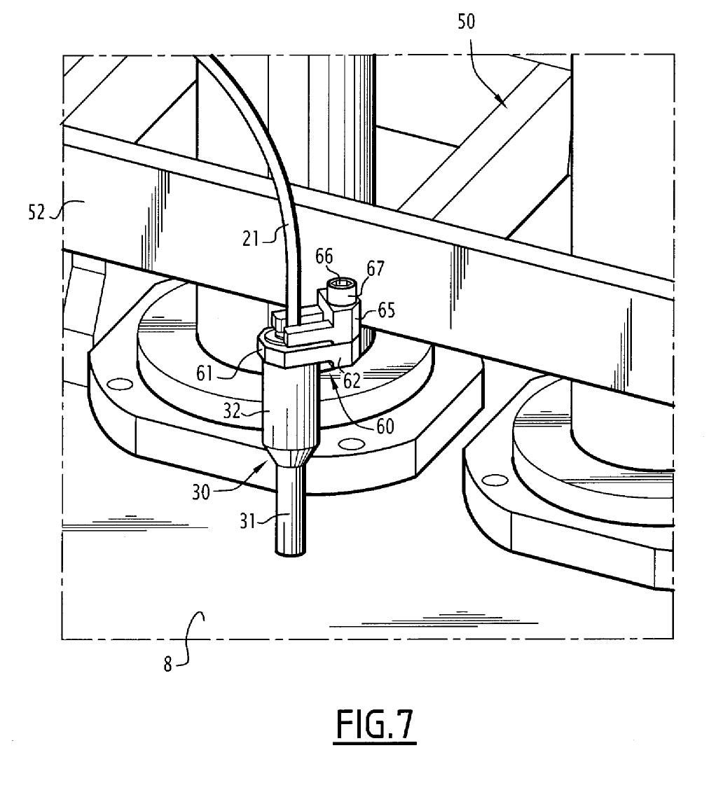

FIGS. 6 and 7 are perspective schematic views showing the steps of the automatic connection method according to the invention.

Shown schematically in FIG. 1, and denoted by the reference 1, is the vessel of a pressurized-water nuclear reactor. Conventionally, placed inside the vessel 1 of the nuclear reactor is the core 2 consisting of fuel assemblies 3 juxtaposed in such a way that the longitudinal axis of the fuel assemblies is vertical. The reactor core 2 is placed inside the lower internals denoted by the general reference 4, which in particular include the baffle assembly 5 of the core.

The nuclear reactor also includes upper internals denoted by the general reference 6, which rest on the upper face of the fuel assemblies of the core via an upper core plate 7.

As may be seen in FIG. 1, the upper internals 6 include a guide tube support plate 8, which hereafter will be called support plate 8. This support plate 8 lies parallel to the upper core plate 7 constituting the lower part of the upper internals 6 and which is produced so as to fasten the upper internals 6 inside the vessel 1.

The upper internals 6 include guide tubes, denoted by the general reference 9, which are made up, each above the support plate 8, of an upper part 9a having a circular cross section and, between the support plate 8 for the upper internals 6 and the upper core plate 7, of a lower part 9b generally having an approximately square cross section with rounded corners. Each of the parts 9a and 9b constitutes a guide tube 9 for the upper internals 6 allowing the vertical displacement of a control rod cluster regulating the reactivity in the nuclear reactor core, said cluster being connected to a suspension/displacement shaft, the vertical displacement of which is provided by a mechanism (not shown) located above the closure head 1a of the vessel 1.

Placed between the support plate 8 of the upper internals 6 and the upper core plate 7 are, in addition to the lower parts 9b of the guide tubes 9, support columns 10 for maintaining the separation between the upper core plate 7 and the support plate 8.

FIG. 2 shows schematically and in perspective the upper face of the support plate 8 that carries the upper parts 9a of the guide tubes 9 and, in the exemplary embodiment shown in this figure, two thermocouple columns 20 that extend parallel to the guide tubes 9 above the support plate 8.

Conventionally, placed in each of the thermocouple columns 20 is a group of upper guide ducts 21, each for guiding a thermocouple (not shown) allowing the temperature of the coolant at the outlet of a preselected group of assemblies of the nuclear reactor core to be measured.

As shown in FIG. 2, several upper guide ducts 21 are placed in a column 20 and emerge from this column via peripheral openings made above the bottom of the thermocouple column 20 in order for each to join a tap denoted by the general reference 30 and intended for the thermocouple to pass through the support plate 8. In this figure, a limited number of upper ducts 21 has been shown so as not to overload the figure.

As shown in particular in FIG. 4, in order to allow passage of a thermocouple, each tap 30 includes a sleeve 32 fixed to the free end of the guide tube 31 placed in alignment with an orifice 22 made in the support plate 8 substantially plumb with a zone in which the temperature measurement has to be carried out by the corresponding thermocouple.

Placed inside each tap 30 is a lower guide duct 23 for guiding a thermocouple.

After the reactor has operated for a certain time, it may be the case that several thermocouples no longer provide any information, so that it is no longer possible to have a reliable and representative image of the actual temperature of the coolant in the reactor core.

Thus, during a reactor shutdown for a repair or for refuelling, it may prove necessary to replace one or more thermocouple columns, and also the existing thermocouples.

To do this, the upper internals, comprising the upper core plate 7, the support plate 8, the guide tubes 9 and the existing thermocouple columns 20 are extracted from the reactor vessel 1 and placed on a servicing stand provided in the nuclear reactor pit.

This pit is filled with water up to its upper level and the various servicing operations are usually carried out from a pit bridge above the upper level of this pit.

After the upper internals 6 have been placed on the servicing stand, the operation of extracting the thermocouples, the thermocouple columns 20 and the upper guide ducts 21 is carried out.

The replacement of the old thermocouple columns with new thermocouple columns 20 is carried out by means of an assembly denoted by the general reference 50 and shown schematically in FIG. 3. This assembly 50 is described in French Patent Application 2 883 096, also in the name of the Applicant.

This replacement assembly 50 will be briefly described below.

The replacement assembly 50 comprises an intermediate structure 51 formed by a grid of horizontal beams 52 fastened together. The intermediate structure 51 has an approximately rectangular outline provided at each of its corners with elements 53 for bearing on the upper face of the support plate 8. The intermediate structure 51 includes two replacement thermocouple columns 20 each pre-equipped with upper ducts 21 for guiding new thermocouples. To do this, the lower part of each thermocouple column 20 comprises openings 20a via which the upper guide ducts 21 emerge.

As may be seen in FIG. 3, the grid of beams 52 forms predetermined paths for fixing the upper ducts 21 for guiding the new thermocouples so that, when the intermediate structure 51 pre-equipped with the thermocouple columns 20 and with the upper guide ducts 21 has been put into position, an end-piece 24 on the free end of each upper guide duct 21 coincides with a predetermined tap 30 on the support plate 8. The free end of each upper duct 21 corresponds to the end intended to cooperate with a tap 30.

Before the intermediate structure 51 thus pre-equipped has been put into position, each preselected tap 30, that is to say each tap intended to receive a new thermocouple, is equipped with a lower duct 23 for guiding this new thermocouple, as shown in FIG. 4.

When putting the intermediate structure 51 into position, the end-piece 24 of each upper guide duct 21 must be placed in alignment with the corresponding lower guide duct 23 so as to ensure continuity during introduction of the new thermocouple, while still allowing a slight misalignment.

To do this, the upper guide ducts 21 and the lower guide ducts 23 are connected together via an automatic remote connection device according to the invention, denoted by the general reference 40.

One connection device 40, for connection between an upper duct 21 and a lower duct 23 for guiding a thermocouple, will now be described with reference to FIGS. 4 to 7, the other connection devices 40 being identical.

As shown in these figures, the automatic remote underwater connection device 40 comprises a plug 41 fastened to the lower guide duct 23 which includes, for this purpose, an end-piece 42. The plug 41 has, at its upper end, a bore 43 for accommodating the end-piece 24 on the end of the upper duct 21 for guiding the thermocouple. The bore 43 and the end-piece 24 have complementary, preferably conical, profiles. In addition, the plug 41 includes an axial passage 45a of diameter substantially equal to the inside diameter of the respective upper 21 and lower 23 ducts.

The plug 41 also includes locking means in the housing of the sleeve 32, which are formed by a quarter-turn snap-fastening system. This quarter-turn snap-fastening system comprises at least two opposed shoulders 45, provided on the periphery of the plug 41 (see FIG. 5). The quarter-turn snap-fastening system also includes a peripheral ring 46 placed in the housing of the sleeve 32 and which includes at least two opposed passages 47 for said shoulders 45. The ring 46 is fastened to the sleeve 32.

The connection device 40 is also provided with retaining means for keeping the plug 41 in the locked position in the sleeve 32.

As shown in FIG. 4, the means for keeping the plug 41 in the locked position are formed by a collar 48 for bearing on the shoulders 45 of the plug 41 and by a resilient member 49 interposed between the collar 48 and the bottom of the housing of the sleeve 32. This resilient member consists of a compression spring 49 exerting an upwardly directed vertical force in order to keep the shoulders 45 of the plug 41 clamped between the collar 48 and the ring 46.

Finally, the connection device 40 also includes means for blocking and aligning the respective upper 21 and lower 23 ducts for guiding the thermocouple.

These blocking means, shown in greater detail in FIGS. 6 and 7, are formed from two elements, a nut 60 and a fork 65 respectively. The nut 60 has, on the one hand, a main part 61 mounted so as to rotate freely on the plug 41 and intended to bear on the upper edge of the sleeve 32, as shown in FIG. 4, and, on the other hand, by an extension 62 extending towards the outside of the sleeve 32, as shown in FIG. 6. The extension 62 of the nut 60 is provided with a threaded hole 63.

The fork 65 bears on the conical end-piece 24 of the upper guide duct 21 and this fork 65 is connected to the nut 60 via at least one screwing member 66 preferably consisting of a captive bolt. The head of the bolt 66 is equipped with a lock cup 67 for preventing this bolt 66 from rotating (see FIG. 7) by said lock cup being clamped in the notches of the bolt head, the lock cup itself being prevented from rotating at its base.

The automatic connection between an upper duct 21 and a lower duct 23 will now be described, the automatic connection between all of these ducts being carried out in a similar manner.

Of course, all the operations are carried out remotely and under water, in particular by means of handling masts.

The intermediate structure 50 is equipped with replacement thermocouple columns 20 and the upper guide ducts 21 are fixed to the beams 52 along predetermined paths that depend on the preselected taps 30.

Before the lower guide duct 23 is introduced into the corresponding tap 30, a nut 60 is mounted so as to rotate freely on the plug 41 of this lower duct 23. This nut 60 is kept in place by a shoulder 41a provided on the upper edge of said plug 41, as shown in FIG. 4.

The lower guide duct 23, thus pre-equipped with the plug 41 and with the nut 60, is introduced into the corresponding tap 30.

During this introduction, the shoulders 45 of the plug 41 pass through the passages 47 in the peripheral ring 46 and bear on the collar 48, compressing the resilient member 49. These shoulders 45 pass below the peripheral ring 46, and the plug 41 is rotated remotely by an operator through one quarter of a turn in order to position the shoulders 45 below the peripheral ring 46. The plug 41 and the lower guide duct 23 are therefore locked, by the shoulders 45 being clamped between the collar 48 and the peripheral ring 46 under the force exerted by the resilient member 49, as shown in FIG. 4.

Next, the assembly consisting of the intermediate structure 51, the replacement thermocouple columns 20 and the upper ducts 21 for guiding the new thermocouples is brought to the servicing stand and gradually lowered into this stand. Given that each upper guide duct 21 is prearranged on the beams 52 of the intermediate structure 51, the end-piece 24 on the end of the upper guide duct 21 coincides with the preselected tap 30 and, during the operation of positioning the intermediate structure 51, this end-piece 24 on the end of the upper duct 21 is housed in the preselected tap 30, as shown in FIG. 6.

The plug 41, the lower guide duct 23 and the upper guide duct 21 are blocked in the sleeve 32 of the tap 30 by placing the fork 65 on the upper duct 21 above the end-piece 24 on the end of this upper duct 21. The gap between the two branches of the fork 65 is smaller than the width of said end-piece 24. A screwing member 66 is screwed into the hole 63 of the extension 62 of the nut 60 so as to fasten the fork 65 to this nut 60.

The bolt is prevented from rotating by the clamping of the lock cup 67.

The connection device according to the invention therefore makes it possible for the respective upper and lower guide ducts to be automatically connected, remotely and under water, so as to ensure continuity during introduction of the new thermocouple, while still allowing a slight misalignment.

1. Automatic connection device for remotely connecting, under water, the upper and lower ducts for guiding a thermocouple for the upper internals of a nuclear reactor, said upper internals comprising a support plate bearing:
guide tubes for the control rod clusters that regulate the reactivity of the core;
at least one thermocouple column containing at least an upper duct;
at least one tap for passage of the lower duct, which tap comprises a tube for guiding the lower duct and is provided, at its free end, with a sleeve for housing of said connection device,
wherein it comprises:
a plug fastened to the lower duct, comprising, on the one hand, a bore for accommodating a conical end-piece on the end of the upper duct and, on the other hand, locking means for locking it in the housing of the sleeve;
retaining means for keeping the plug in the locked position in the sleeve; and
means for blocking the plug and for aligning the lower duct and the upper duct in said sleeve of the tap.

2. Device according to claim 1, wherein the means for locking the plug of the lower duct are formed by a quarter-turn snap-fastening system.

3. Device according to claim 2, wherein the quarter-turn snap-fastening system comprises at least two opposed shoulders, provided on the periphery of the plug, and a peripheral ring placed so as to be fastened to the sleeve in the housing of said sleeve, having at least two opposed passages for said shoulders.

4. Device according to claim 3, wherein the retaining means are formed by a collar for bearing on the shoulders of the plug and by a resilient compression member that exerts an upwardly directed vertical force in order to keep the shoulders clamped between the collar and the peripheral ring.

5. Device according to claim 1, wherein the means of blocking and aligning the upper and lower ducts comprise, on the one hand, a nut mounted so as to rotate freely on the plug of the lower duct and intended to bear on the upper edge of the sleeve and, on the other hand, a fork for bearing on the conical end-piece on the end of the upper duct and connected to said nut by at least one screwing member.

6. Automatic connection method for remotely connecting, under water, the upper and lower guide ducts for guiding a thermocouple for the upper internals, by means of a connection device according to claim 1, wherein it consists:
in mounting the nut so as to rotate freely on the plug of the lower duct;
in introducing the lower duct equipped with the plug and with the nut into the tap;
in making the shoulders of the plug pass into the passages of the peripheral ring by compressing the resilient member;
in rotating the plug by a quarter of a turn in order to position the shoulders below the peripheral ring and thus lock the plug and the lower duct by clamping said shoulders between the collar and the peripheral ring under the restoring force of the resilient member;
in fitting the upper duct into the corresponding thermocouple column;
in placing the thermocouple column on the support plate, the end-piece on the end of the upper duct being housed in the accommodating bore of the plug;
in placing the fork on the nut;
in fastening the fork to the nut by the screwing member; and
in preventing the screwing member from rotating.
